(19) United States
(12) Patent Application Publication
(10) Pub. No.: US 2007/0277704 A1
(43) Pub. Date: Dec. 6, 2007

(54) CARBON FOAM ARTICLES FROM SHAPED THERMOSETTING PLASTIC FOAM

(75) Inventors: Rick Lucas, St. Clairsville, OH (US); Thomas M. Matviya, McKees Rocks, PA (US)

Correspondence Address: PHILIP D. LANE, P.O. BOX 79318, CHARLOTTE, NC, 28271-7063, US

(73) Assignee: TOUCHSTONE RESEARCH LABORATORY, LTD., Triadelphia, WV (US)

(21) Appl. No.: 11/421,858

(22) Filed: Jun. 2, 2006

(51) Int. Cl. C09C 1/44

(52) U.S. Cl. 106/472

(57) ABSTRACT

A method for producing a one-piece carbon foam article having a complex geometric shape is described. The method may include heating a carbonizable polymeric foam article having a complex geometric shape to temperature sufficient to carbonize the polymer foam and produce carbon foam. The resulting carbon foam article retains substantially the same shape and physical pore structure of the carbonizable polymeric foam article.

### BRIEF SUMMARY OF THE INVENTION

The present invention is directed to producing a unitary, one-piece, or otherwise integral carbon foam article having a complex geometric shape. The method may include heating a carbonizable polymeric foam article that has a predetermined complex geometric shape to a temperature that is sufficient to carbonized the polymer foam and convert the polymeric foam article into a carbon foam article that has substantially the same shape and physical pore structure as the carbonizable polymeric foam article.

In some embodiments, the invention may include a method for the production of a carbon foam article, comprising the steps of providing a carbonizable polymeric foam article having a complex geometric shape and comprised of one continuous piece of carbonizable polymeric foam, and carbonizing said carbonizable polymeric foam article to provide a carbon foam article exhibiting said complex geometric shape and comprised of one continuous piece of carbon foam.

### BRIEF DESCRIPTION OF THE DRAWINGS

FIG. 1 is an illustration of a carbonizable polymeric foam article having a complex geometric shape in accordance with an embodiment of the invention.

FIG. 2 is an illustration of a carbonizable polymeric foam article having a complex geometric shape in accordance with another embodiment of the invention.

FIG. 3(A) is an illustration of a carbonizable polymeric foam article having a complex geometric shape in accordance with still another embodiment of the invention.

FIG. 3(B) is an illustration of a carbonizable polymeric foam article having a complex geometric shape in accordance with yet another embodiment of the invention.

FIG. 4 is an illustration of a carbonizable polymeric foam article having a complex geometric shape in accordance with other embodiments of the invention.

FIG. 5 is an illustration of a carbonizable polymeric foam article having a complex geometric shape in accordance with certain embodiments of the invention.

FIG. 6 is an illustration of a carbonizable polymeric foam article having a complex geometric shape in accordance with certain additional embodiments of the invention.

### DETAILED DESCRIPTION OF EMBODIMENTS OF THE INVENTION

The present invention is directed to one-piece carbon foam articles and a method for the production of such one-piece carbon foam articles. The carbon foam articles of the present invention are characterized in that they are comprised of one continuous non-planar piece of carbon foam. That is, the carbon foam comprising the articles of the present invention is not comprised of two or more sections of carbon foam bonded or otherwise attached together. The one-piece carbon foam articles may be characterized in that they exhibit a complex geometric (i.e three dimensional) shape. Such complex geometric shapes are not any simple classical geometric shape, such as a solid parallelepiped, a solid sphere, a solid ellipsoid, a solid cylinder, a hollow cylinder, a solid circular cone, a solid pyramid, a solid frustrum, or a solid torus. Rather, the three dimensional shapes of the carbon foam articles may encompasses elements of any of the aforementioned classical geometric shapes in any combination, including those in combination with non-classical shapes or irregular surfaces. Additionally, the three dimensional shapes of the carbon foam articles may encompass those shapes having interior volumes wherein the interior volume surface of the carbon foam is continuous with the outer surface of the carbon foam. That is, the interior volume is not completely enclosed by carbon foam but has at least one area open to the volume surrounding the carbon foam article.

A great number of different shapes may comprise the complex geometric shapes of the carbon foam article. Such shapes may include those having flat and/or curved and/or irregular surfaces. For example, in some embodiments the complex geometric shapes of the carbon foam article may comprise those shapes having more than 6 flat surfaces. In other embodiments the complex geometric shapes of the carbon foam article may comprise those shapes having more than 8 flat surfaces. In still other embodiments, the complex geometric shapes of the carbon foam article may comprise those shapes having more than 10 flat surfaces. The complex geometric shapes may also comprise those shapes having curved surfaces. For example, the complex geometric shapes may comprise those shapes having more than 2 curved surfaces. In other embodiments, the complex geometric shapes may comprise those shapes having 2 curved surfaces in combination with more than 2 flat surfaces. In still other embodiments, the complex geometric shapes may comprise those shapes having one curved surface in combination with more than 2 flat surfaces. The complex geometric shapes may also comprise those shapes having one or more irregular surfaces. Typically, irregular surfaces exhibit a surface area greater than that of a smooth surface placed upon that irregular surface.

The method of producing the carbon foam articles may include a method by which numerous, essentially identical, carbon foam articles of complex geometries may produced without the extensive fabrication and machining time previously associated with the production of such articles. The carbon foam articles may be used, for example, as enclosures, supports, strengthening members, struts, thermal shields, structural elements, decorations, composite tool bodies, templates, composite tool bodies, decorations, and the like.

The carbon foam articles may be prepared from a carbonizable polymeric foam. Carbonizable polymeric foams are polymeric foams that carbonize, when exposed to sufficiently high temperatures, to produce carbon foams. The carbon foams resulting from such carbonization essentially retain substantially the same shape and physical cell structure as was exhibited by the polymeric foam prior to carbonization, although some shrinkage and minor deformation usually does occur. Suitable carbonizable polymeric foam may be produced from, or comprise, various carbonizable synthetic polymeric materials. Such carbonizable synthetic polymeric materials may comprise phenolic resins, furan resins, or resorcinol resins. Other types of suitable carbonizable synthetic polymeric materials that may be suitable for forming carbonizable polymeric foams may include, but are not limited to, those comprising vinylidene chloride, furfuryl alcohol, polyacrylonitrile, polyurethane, combinations thereof, and the like. In some embodiments, a suitable carbonizable polymeric foam may include, but is not limited to, those foams commonly referred to as phenolic foams.

The carbonizable polymeric foam articles may be formed by foaming the resin to a desired size and shape using conventional methods in a mold. Typically, the mold interior will have essentially the complex geometric shape and approximate size of the desired carbon foam article such that minimally a single piece of carbonizable polymeric foam is produced therein having essentially that mold interior size and shape. In this manner, a carbonizable polymeric foam article may be produced having essentially the shape of the desired carbon foam article.

Alternatively, an essentially unshaped molded volume of carbonizable polymeric foam may be formed by cutting and/or machining, using conventional methods, to result in a sized and shaped carbonizable polymeric foam article having essentially the complex geometric shape and approximate size of the desired carbon foam article.

In another embodiment, the mold interior may be configured such that the carbonizable polymeric foam formed therein exhibits a repeating geometry. The repeating geometry of the carbonizable polymeric foam formed therein constitutes volumes of polymeric foam that may essentially exhibit the complex geometric shape of the desired carbon foam article except where connected to neighboring volumes of carbonizable polymeric foam. Separation of the neighboring volumes of carbonizable polymeric foam may provide carbonizable polymeric foam articles of the desired geometries with minimal machining. For some geometric shapes and well-designed molds the machining may be as simple as a saw cut.

Typically, the carbonizable polymeric foam article is somewhat larger than is the desired carbon foam article. The mold used to form the carbonizable polymeric foam may be so designed and constructed that multiple pieces, and/or designs, of polymeric foam articles may be simultaneously produced. Preferably, the mold is reusable so that multiple carbonizable polymeric foam pieces may be produced without the necessity of re-tooling. Additionally, the mold used to form the carbonizable polymeric foam may be so designed and constructed that the foam produced therein exhibits one or more partially enclosed volumes, thicker or thinner areas or volumes, surface ridges or groves in the surface of the polymeric foam, designs on the surface of the foam, and the like.

Extraneous portions of the as-produced polymeric foam article volume may be removed by conventional cutting and/or machining methods to result in a sized and shaped carbonizable polymeric foam article having essentially the complex geometric shape and approximate size of the desired carbon foam article. In certain embodiments, the mold may be designed such that post-forming shaping and/or sizing of the carbonizable polymeric foam may be minimized. Such minimization may be achieved by incorporating as much as feasible of the desired complex geometric shape of the carbon foam article into the mold design. Sometimes, regardless of the complexity of the mold design, further shaping and/or sizing of the sized and shaped as produced carbonizable polymeric foam article may be necessary in that area corresponding to any volume of the mold intended for free expansion of the foam during forming and/or in any areas of the foam piece corresponding to the location of resin introduction into the mold prior to foaming.

By these methods, a single piece of carbonizable polymeric foam (i.e. a carbonizable polymeric foam article) may be produced such that the carbonizable polymeric foam article has essentially the shape of the desired carbon foam article.

Generally, the sized and shaped polymeric foam article is produced somewhat oversize with respect to the desired final dimensions of the carbon foam article. Such oversize production may be desirable as the polymeric foam will often shrink in all three dimensions when subsequently carbonized during conversion of the polymeric foam to carbon foam. The degree of this shrinkage is typically exposure temperature dependent and may be readily determined by routine experimentation.

Once it is of the desired size and shape, the formed carbonizable polymeric foam article is heated to elevated temperatures, by use of known methods, to carbonize the polymeric foam to produce a carbon foam article. If the dimensions of the as-produced carbon foam are not within the tolerances desired or required for the article, the carbon foam may be machined, or otherwise shaped, to the desired dimensions. Machining may be accomplished by use of conventional methods. Carbide tooling is typically recommended for such machining. It is advantageous to minimize any post-carbonization machining or shaping of the carbon foam article by incorporating as much detail of the desired carbon foam article size and shape into the mold as possible.

Heating of the foam to effect carbonization may be conducted such that cracking, warping, and/or possible breakage of the resultant carbon foam is minimized or does not occur. Such degradation of the carbon foam may be the result of the development of significant thermal gradients within the foam during heating. In certain embodiments, heating of the polymeric foam or the resultant carbon foam may be conducted in a non-reactive, inert, essentially oxygen free atmosphere. Likewise, cooling of the foam may be conducted in a non-reactive, inert, essentially oxygen free atmosphere until the carbon foam temperature is minimally less than about 400° C. and more preferably less than about 150° C.

Heating of the polymeric foam or the resultant carbon foam to a maximum desired elevated temperature may be conducted in a continuous manner. Alternatively, such heating may be conducted as a series of steps performed in one or more pieces of heating equipment. For example, the polymeric foam may be carbonized in one furnace and further carbonized in a second furnace, and exposed to graphitization temperatures in a third furnace. As an alternative example, the polymer foam may be carbonized, and further heated, even to graphitization temperatures, in a single furnace.

As used in this specification, carbonization of the foam is considered to initiate at temperatures greater than room temperature and less than about 700° C. For some carbonizable polymeric foam articles, carbonization initiates at a temperature of from about 250° C. to about 700° C. In some embodiments, carbonization may be further conducted at temperatures greater than about 700° C., even to temperatures as great as about 3200° C. or higher. Graphitization temperatures are a subset of the range of carbonization temperatures and usually are considered to extend from about 1700° C., up to about 3200° C. or higher. The strength, thermal conductivity, and electrical conductivity of carbon foam may increase with respect to the maximum temperature to which the foam has been exposed, typically during preparation. In some embodiments, it may be advisable to heat the foam to minimally about 700° C. Heating the foam to temperatures greater than about 1000° C. is usually even more advisable in other embodiments as the foam strength and electrical conductivity may be improved which is beneficial for foam utilization in certain applications. If desired, the resultant carbon foam article may be heated to temperatures as great as 3200° C. or more.

The carbon foam of the carbon foam article may exhibit a wide range of properties depending upon variables including, but not limited to, the particular carbonizable polymer foam used, the polymer foaming conditions, and the carbonization times and temperatures used to produce the carbon foam article. The carbon foam may exhibit a bulk density ranging from about 0.01 g/cc to about 1 g/cc. In some embodiments, the carbon foam may exhibit a bulk density ranging from about 0.01 g/cc to about 0.8 g/cc. Further, the carbon foam may exhibit compressive strengths ranging from about 50 p.s.i. to about 12,000 p.s.i., or greater. In some embodiments, the carbon foam may exhibit compressive strengths ranging from about 150 p.s.i. to about 10,000 p.s.i. Other properties of the carbon foam may include thermal conductivities ranging from about 0.05 W/mK to about 0.4 W/mK.

The carbon foam articles may be fully or partially surface coated, covered, and/or faced with other materials using conventional methods. These other materials may extend from the surface of the carbon foam article in any manner. Such other materials may provide, for example, additional article strength, waterproofing, impact resistance, and the like. Such other materials may comprise, but are not limited to, carbon foam, fiberglass, thermosetting and thermoplastic polymers, ceramics, paint, polymer composites, carbon composites, wood, paper, metals, metal composites, and the like. As desired or required, such other materials may be applied, for example, by dipping, spraying (including thermal spraying), lay-up methods, painting, mechanical fasteners, deposition (including chemical vapor deposition and vacuum deposition), and the like. The carbon foam articles may also be fully or partially impregnated with thermosetting or thermoplastic polymers, resins, ceramics, metals, tars, pitches, carbon, and the like. Such impregnation may provide for additional article strength, bracing, waterproofing, impact resistance, and the like. Interior or exterior supports may be affixed to the carbon foam comprising the article. Such supports may be comprised of any solid material having sufficient strength to provide additional support to the article. Such solid materials may include, but are not limited to, wood, solid polymers, polymeric composites, metals, metallic composites and carbon foam. Additionally, the carbon foam articles of the present invention may be incorporated into other articles, devices, assemblies, and the like.

The carbon foam articles of the present invention may be used, for example, as supports, strengthening members, struts, thermal shields, EMI shields, templates, composite tool bodies, decorations, mirror supports, parts of various assemblies, and the like. The carbon foam articles of the present invention may also be incorporated into other articles or devices including, but not limited to, airframes, missile bodies, furnaces, and other assemblies for which the incorporation of such carbon foam articles would be advantageous.

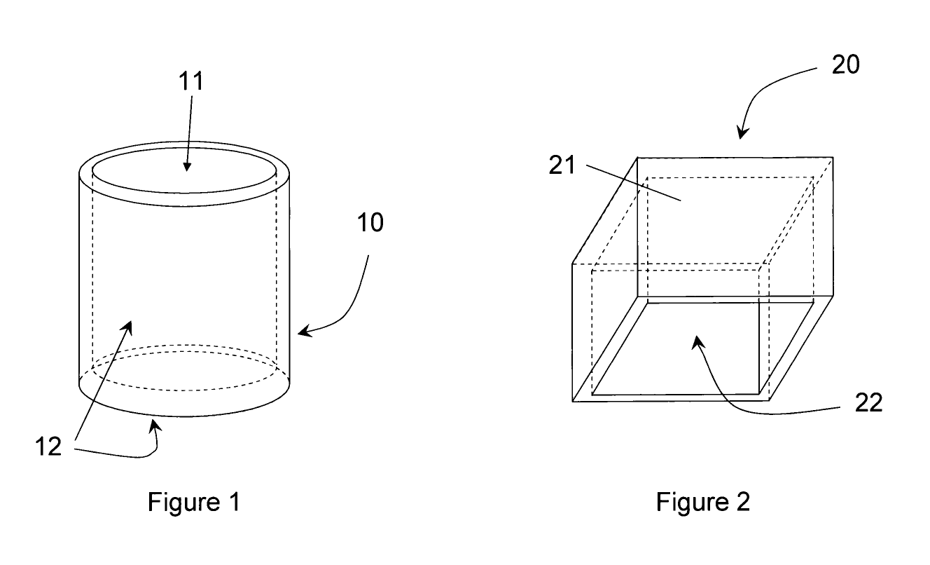

With reference now to FIG. 1, there is shown a carbonizable carbon foam article in the form of a closed end cylinder 10. The carbonizable carbon foam article 10 may have been produced using a suitably shaped mold, to provide a closed end cylinder as represented in FIG. 1. Such a closed end cylinder 10 provides a partially enclosed volume in area 11 partially bounded by polymeric foam walls 12. The polymeric foam is continuous throughout the article. The polymeric foam article is heated to an elevated temperature sufficient to carbonize the polymeric foam and result in a carbon foam article. In certain embodiments, the elevated temperature is minimally 700° C. In other embodiments the elevated temperature may be at least about 950° C. As desired, the foam may be heated to even higher temperatures. Following heating, the resultant carbon foam article is cooled. Heating of the polymeric foam article or the resultant carbon foam article may be conducted in a non-reactive, oxygen free, essentially inert atmosphere. Likewise, cooling of the foam article may be conducted in a non-reactive, oxygen free, essentially inert atmosphere until the carbon foam temperature is minimally less than about 400° C., and in other embodiments, less than about 150° C.

The resultant carbon foam article is typically smaller than the cast polymeric foam article but exhibits substantially the same shape and physical cell structure. As illustrated, the methods described herein provide for carbon foam articles having complex geometric shapes and are comprised of continuous carbon foam. The complex geometric shape of the resultant article exhibits two curved surfaces (the inside and outside surfaces of the cylinder) and three flat surfaces (the top of the cylinder, the bottom of the cylinder, and the inside bottom of the cylinder). The surfaces of such a carbon foam article may be partially or fully coated, covered, or faced as discussed above. The carbon foam may be impregnated as discussed above. Supports of other material(s) may be attached to the article. Such a carbon foam article may be used, for example, to provide thermal, impact, or blast protection to materials, objects, personnel, and the like within the partially enclosed volume of the carbon foam article.

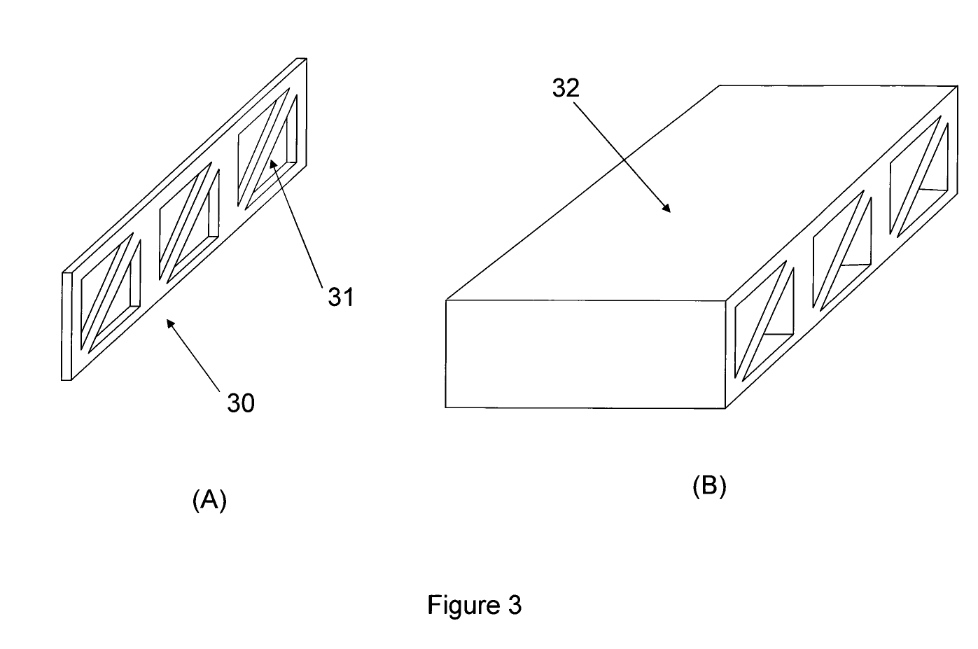

With reference now to FIG. 2, there is shown a carbonizable polymeric foam article 20 cast or otherwise formed in rectangular shape having a rectangular shaped interior volume, using a suitably shaped mold. In this illustration, the interior volume of the article 20 is not enclosed and the surface of this interior volume is continuous with the outer surface of the carbonizable polymeric foam article. As illustrated, the carbonizable polymeric foam article 20 has exterior walls 21 and a partially enclosed interior volume 22. The described polymeric foam article is heated to elevated temperatures to convert the polymeric foam to carbon foam as discussed above. The resulting carbon foam article may be cooled as discussed above.

The resultant carbon foam article is typically smaller than the cast/molded polymeric foam article but exhibits substantially the same shape and physical cell structure. The carbon foam of this article is one piece and continuous. The method described herein provides for a carbon foam article, of complex geometric shape, comprising continuous carbon foam. The complex geometric shape of the resultant article exhibits eleven flat surfaces (the outer sides, top, and bottom of the article and the five interior surfaces). The surfaces of such a carbon foam article may be partially or fully coated, covered, or faced with any of a number of materials as discussed above. The carbon foam of the article may be impregnated as discussed above. Supports of other material(s) may be attached to the carbon foam article.

Such a carbon foam article may be used for a number of purposes. For example, such a carbon foam article may be used as an enclosure to shield objects in the enclosed volume from, high temperatures, impacts, EMI, shock, electrical discharges, detonations, and the like.

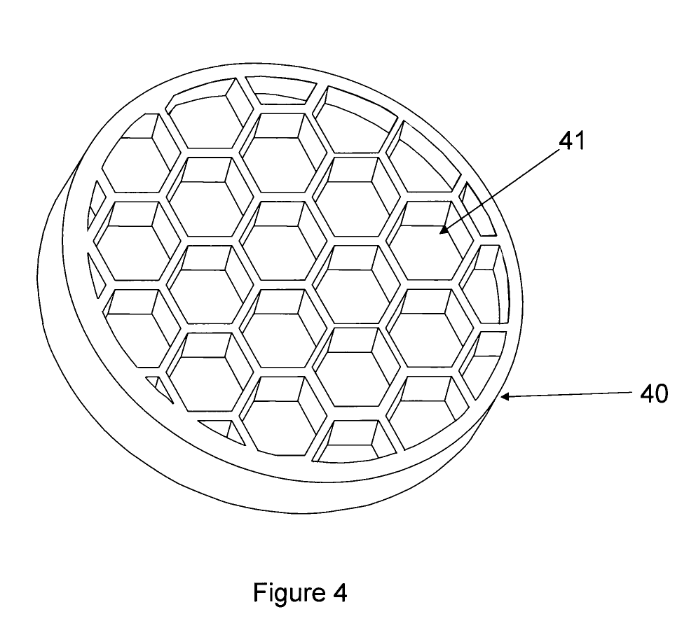

In a further embodiment, consider a carbonizable polymeric foam cast, or otherwise produced, using a suitably shaped mold, to provide a polymeric foam article as represented in FIG. 3(A). The cast polymeric foam article 30 as represented in FIG. 3(A) is similar in form to a truss as angled supporting members 31 provide for additional strength in the relatively light weight article. The illustrated article could be molded as shown in illustration 3(A). Alternatively, a much thicker version of the article could be molded from which a plurality of the articles illustrated in FIG. 3(A) could be sliced by transverse cuts. Such a thicker version 32 of the article is illustrated in FIG. 3(B). A plurality of carbonizable polymeric foam articles may be produced from a single carbonizable polymeric foam article having a complex geometric shape to provide a plurality of carbonizable polymeric foam articles each having a second complex geometric shape.

The carbonizable polymeric foam article of FIG. 3(A) is carbonized, and the resultant carbon foam article cooled, as previously discussed. Alternatively, the carbonizable polymeric foam article of FIG. 3(B) could be carbonized, and the resultant carbon foam article cooled. A plurality of carbon foam articles having the same configuration as that resulting from the carbonization of the carbonizable polymeric foam article of FIG. 3(A) could then be produced by appropriate slicing of the carbonized carbonizable polymeric foam article, i.e., carbon foam article, of FIG. 3(B). Accordingly, the carbon foam article having a complex geometric shape may be sub-divided to provide a plurality of carbon foam articles each having a second complex geometric shape.

The resultant carbon foam article is smaller than the cast polymeric foam article but exhibits substantially the same shape and physical cell structure. The carbon foam article has a truss-like configuration where the carbon foam is one piece and continuous through all walls. The method described herein provides for a carbon foam article, of complex geometric shape, comprising continuous carbon foam. The complex geometric shape of the resultant article exhibits 24 flat surfaces (the outer sides, top, bottom, front, and back of the article and the eighteen interior surfaces). The surface of such a carbon foam article may be partially or fully coated, covered, or faced with any of a number of materials as discussed above. The carbon foam article may be impregnated as discussed above. Supports of other material(s) may be attached to the article as also discussed above. Such an article may be used, for example, as a supporting member, a reinforcement, and the like.

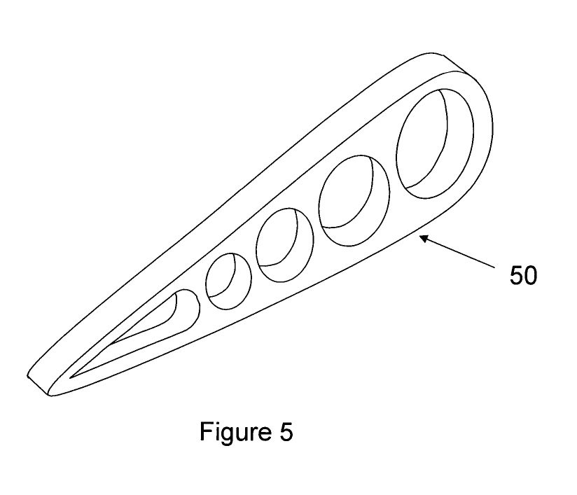

In yet another embodiment, consider a carbonizable polymeric foam article cast, or otherwise molded, using a suitably shaped mold, to provide an article as represented in FIG. 4. Such an article 40 has a disk like shape with numerous hexagonal-like recesses 41 in one major surface. The carbonizable polymeric foam article may be carbonized, and the resultant carbon foam article cooled, as discussed above.

The resultant carbon foam article is smaller than the cast polymeric foam article but exhibits substantially the same shape and physical cell structure. The carbon foam is one piece and continuous through the article. Therefore, the method provides for a carbon foam article, of complex geometric shape, comprising continuous carbon foam. The complex geometric shape of the resultant article exhibits a great number of flat and curved surfaces (approximately 129 flat surfaces and 17 curved surfaces). The surfaces of such a carbon foam article may be partially or fully coated, covered, or faced with any of a number of materials as discussed above. The carbon foam may be impregnated as discussed above. Supports of other material(s) may be attached to the carbon foam article. Typically, such a carbon foam article is used as an astronomical telescope mirror support. Carbon foam articles having such complex geometries would be very time consuming to produce by conventional methods. But, by the methods described, a number of such articles may be produced by carbonization of a shaped carbonizable polymeric foam article produced in an appropriately designed mold. This embodiment further illustrates the advantages for the production of multiple carbon foam articles of the same type.

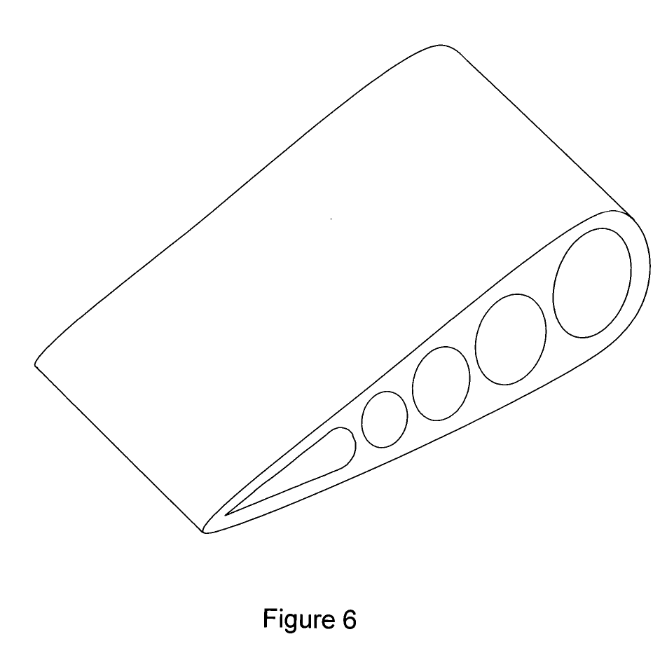

Still further, consider a carbonizable polymeric foam cast, using a suitably shaped mold, to provide an article as represented in FIG. 5 as reference number 50. The carbonizable polymeric foam article may be carbonized, and the resultant carbon foam article cooled, as discussed in the previous illustrations. The resultant carbon foam article is smaller than the cast polymeric foam article but exhibits substantially the same shape and physical cell structure. The carbon foam is one piece and continuous through the article. Therefore, the method provides for a carbon foam article, of complex geometric shape, comprising continuous carbon foam. The complex geometric shape of the resultant article exhibits 2 flat surfaces (the front and back sides) and 6 curved surfaces (1 outer curved surface and 5 interior curved surfaces). The surfaces of such a carbon foam article may be fully or partially coated, covered, or faced with any of a number of materials as discussed above. The carbon foam article may be impregnated as also discussed above. Supports of other material(s) may be attached to the article. The utility of such a carbon foam article may be, but are not limited to, an airfoil truss.

In some embodiments, an article may be individually cast from carbonizable polymeric foam or produced from a larger section of carbonizable polymeric foam as was detailed in the discussion of FIGS. 3(A) and 3(B). Such a larger section of carbonizable polymeric foam is illustrated in FIG. 6.

The methods described herein may be utilized to produce one-piece carbon foam articles suitable for use as tools, molds, molding surfaces, and the like for the production of formed polymeric or polymeric composite articles. Based on the previous illustrations and examples, there are many advantages of the production of such tools, molds, molding surfaces, and the like in accordance with embodiments of the present invention. These advantages are especially useful for the production, from carbon foam, of multiple tools, molds, molding surfaces, and the like of the same configuration.

While the invention has been described in detail with respect to various embodiments, the invention is intended only to be limited by the following claims.

What is claimed is:

1. A method for the production of a carbon foam article, comprising the steps of:
providing a carbonizable polymeric foam article having a complex geometric shape and comprised of one continuous piece of carbonizable polymeric foam; and
carbonizing said carbonizable polymeric foam article to provide a carbon foam article exhibiting said complex geometric shape and comprised of one continuous piece of carbon foam.

2. The method of claim 1, wherein the step of providing said carbonizable polymeric foam article comprises foaming a carbonizable synthetic polymeric material in a mold having essentially the complex geometric shape of said carbonizable polymeric foam article.

3. The method of claim 2, wherein portions of said carbonizable polymeric foam article are removed prior to the step of carbonizing.

4. The method of claim 1, wherein said carbonizable polymeric foam article is provided by shaping an essentially unshaped molded volume of carbonizable polymeric foam.

5. The method of claim 1, wherein said carbonizable polymeric foam article is larger than said carbon foam article.

6. The method of claim 1, wherein said step of carbonizing comprises heating said carbonizable polymeric foam article to a temperature greater than about 700° C. in a non-reactive, inert, essentially oxygen free atmosphere.

7. The method of claim 1, further comprising the step of cooling the carbon foam article, after carbonizing, to a temperature less than about 400° C. in a non-reactive, inert, essentially oxygen free atmosphere.

8. The method of claim 1, further comprising the step of cooling the carbon foam article, after carbonizing, to a temperature less than about 150° C. in a non-reactive, inert, essentially oxygen free atmosphere.

9. The method of claim 1, wherein said complex geometric shape is a shape having six flat surfaces and one other surface.

10. The method of claim 1, wherein said complex geometric shape is a shape having two curved surfaces in combination with more than two flat surfaces.

11. The method of claim 1, wherein said complex geometric shape is a shape having more than two curved surfaces.

12. The method of claim 1, wherein said complex geometric shape is a shape having at least one irregular surface.

13. The method of claim 1, wherein said complex geometric shape is a shape having a curved surface and more than two flat surfaces.

14. The method of claim 1, further comprising the step of sub-dividing said carbonizable polymeric foam article to provide a plurality of carbonizable polymeric foam articles each having a second complex geometric shape and carbonizing said plurality of carbonizable polymeric foam articles to provide a plurality of carbon foam articles each having said second complex geometric shape.

15. The method of claim 1, further comprising the step of sub-dividing said carbon foam article exhibiting said complex geometric shape to provide a plurality of carbon foam articles each having a second complex geometric shape.

16. The method of claim 1, wherein said carbonizable polymeric foam is prepared from a carbonizable synthetic polymeric material comprising at least one material selected from the group consisting of phenolic resin, furan resin, resorcinol resin, vinylidene chloride, furfuryl alcohol, polyacrylonitrile, and polyurethane.

17. The method of claim 1, wherein said carbonizable polymeric foam comprises phenolic foam.
